(19) United States
(12) Patent Application Publication
(10) Pub. No.: US 2024/0162929 A1
(43) Pub. Date: May 16, 2024

(54) CELL PHONE CASE WITH AN ATTACHMENT DEVICE FOR HANDS-FREE RECORDING

(71) Applicant: Keith J. Wingfield, New York, NY (US)

(72) Inventor: Keith J. Wingfield, New York, NY (US)

(21) Appl. No.: 18/054,304

(22) Filed: Nov. 10, 2022

(51) Int. Cl. H04B 1/3827; H04B 1/3888; H04M 1/04

(52) U.S. Cl. CPC H04B 1/385; H04B 1/3888; H04M 1/04

(57) ABSTRACT

A cell phone case with a first bracket extending from a top end of the cell phone case wherein the first bracket includes at least one U-shaped prong to couple the cell phone case to a first attachment device and a second bracket extending from a bottom end of the cell phone case wherein the second bracket includes at least one U-shaped prong to couple the cell phone case to a second attachment device. The first attachment device and the second attachment device are each configured to join the cell phone case to a user's clothing.

### BACKGROUND OF THE INVENTION

The present invention relates to cell phone cases and, more particularly, to cell phone cases with an attachment device.

It is sometimes challenging to record a video with a cell phone. Often, it is difficult to remove a cell phone from a pocket and begin the recording process in time. By the time the cell phone is ready to record, the moment has passed. Presently, there are limited devices which make a cell phone readily available to a user, even more conveniently located than in a user's pocket.

In addition, someone being recorded with a cell phone may become agitated and harass or even attack the person recording, making the recorder a victim. This is often the case because the act of recording, holding a cell phone in an extended hand pointed towards a person being recorded, is obvious and draws attention. For example, in cases of police brutality, an officer may immediately realize he/she is being filmed and attempt to stop or even arrest the person recording unlawfully. Presently, there are limited devices that enable a user to record someone or something in a stealth fashion.

Moreover, there are limited devices that can secure a cell phone to a user even during exercise. Currently available devices are bulky or have a clip that attaches to a belt. However, not everyone wears belts.

As can be seen, there is a need for a device that makes a phone readily available, enables a user to record without drawing attention, and secures the phone to a user without utilizing a belt.

### SUMMARY OF THE INVENTION

In one aspect of the present invention, a cell phone case comprises a first bracket extending from a top end of the cell phone case wherein the first bracket comprises at least one U-shaped prong configured to couple the cell phone case to a first attachment device and a second bracket extending from a bottom end of the cell phone case wherein the second bracket comprises at least one U-shaped prong configured to couple the cell phone case to a second attachment device wherein the first attachment device and the second attachment device are each configured to join the cell phone case to a user's clothing.

Advantageously, the present invention enables a user to stealthily record with a cell phone, without attracting the attention of others.

The present invention further enables a user to securely attach a cell phone to their clothing without requiring a belt. Advantageously, the present invention may be strap free which reduces a burden on a user. The present invention further enables a user to utilize a cell phone hands-free in better range of Bluetooth™ devices.

The present invention further enables a user easy access to a cell phone without having to fumble through pockets to access the phone. It further reduces the chances of misplacing or losing the cell phone because it remains attached to the wearer.

These and other features, aspects and advantages of the present invention will become better understood with reference to the following drawings, description, and claims.

### BRIEF DESCRIPTION OF THE DRAWINGS

FIG. 1 is a perspective view of a cell phone case in use according to an embodiment of the present invention;

FIG. 2 is a front view of the cell phone case thereof;

FIG. 3 is a section view taken on line 3-3 of FIG. 2; and

FIG. 4 is a perspective view of a user holding a cell phone case according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention provides a cell phone case with brackets and an attachment device such as a safety pin for affixing the cell phone case to a user's clothing.

The present invention may comprise a hands free and strapless device for equipping or attaching a cell phone to a user. The present invention may enable a cell phone or similar device to attach to a user's clothing, similar to a police body cam. The clothing may be a sweater, jacket, or shirt worn on a user's torso.

The present invention may be lightweight, small, and almost invisible. Moreover, it presents the phone in readily accessible manner.

The present invention may attach anywhere on an article of clothing by the attachment device. In some embodiments, the attachment device may be a pin such as a safety pin.

The attachment device may be affixed to the cell phone case by a bracket or brackets. A bracket may extend from the cell phone case to grip the attachment device. The bracket may comprise at least one prong, such as a U-shaped prong configured to couple or join the attachment device to the cell phone case. Multiple prongs may extend from the cell phone case to join the case to the attachment device. In some embodiments, two U-shaped prongs form a single bracket. In some embodiments, multiple brackets may extend from the cell phone case.

The attachment device may be a safety pin. The brackets may enable the safety pin to releasably secure the cell phone case to a user's clothing. The safety pin may be interchanged or replaced when damaged.

In some embodiments, multiple safety pins may be affixed to the cell phone case by multiple brackets. For example, in some embodiments, a safety pin may be affixed to a top of the phone case, a center of the phone case, and/or a bottom of the phone case.

In some embodiments, a safety pin may also be built into the cell phone case, making it blend in with the cellphone case as a standard option.

Safety pins utilized by the present invention are not particularly limited, and any safety pin suitable for affixing a cell phone case to a user's clothing may be utilized.

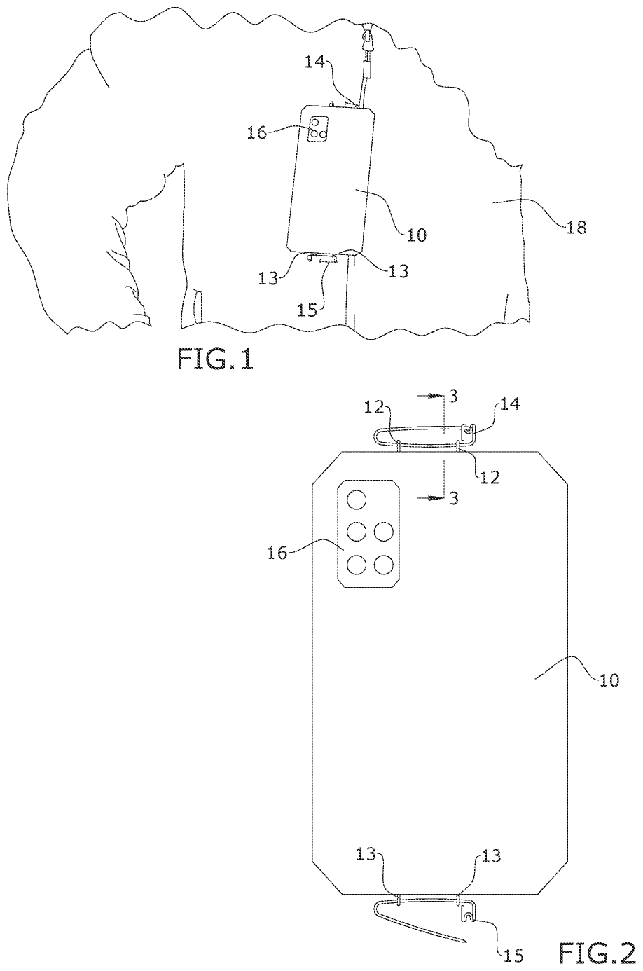

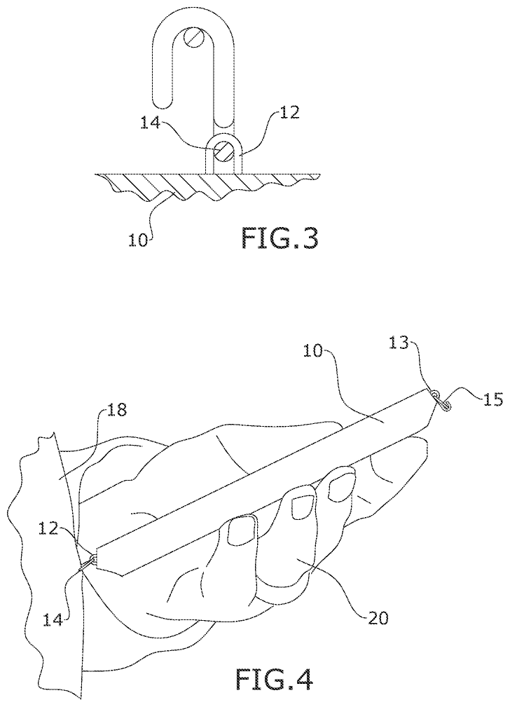

Referring to FIGS. 1-4, a cell phone case 10 comprises a first bracket 12 on a top end of a cell phone case 10 and a second bracket 13 on a bottom end of a cell phone case 10. The first bracket 12 couples the cell phone case 10 to a first safety pin 14. The second bracket 13 couples the cell phone case 10 to a second safety pin 15. The cell phone case 10 houses a cell phone 16.

As shown in FIG. 1, the first safety pin 14 and the second safety pin 15 each releasably secure the cell phone case 10 to a user's clothing 18. Each safety pin 14, 15 attaches to a respective portion of the user's clothing 18.

As shown in FIG. 4, the second safety pin 15 is released from the user's clothing 18, enabling a user 20 to view the cell phone 16 housed within the cell phone case 10 without releasing the cell phone case 10 from the user's clothing 18 completely.

It should be understood, of course, that the foregoing relates to exemplary embodiments of the invention and that modifications may be made without departing from the spirit and scope of the invention as set forth in the following claims.

What is claimed is:

1. A cell phone case comprising:
a first bracket extending from a top end of the cell phone case wherein the first bracket comprises at least one U-shaped prong configured to couple the cell phone case to a first attachment device; and
a second bracket extending from a bottom end of the cell phone case wherein the second bracket comprises at least one U-shaped prong configured to couple the cell phone case to a second attachment device;
wherein the first attachment device and the second attachment device are each configured to join the cell phone case to a user's clothing.

2. The cell phone case of claim 1, wherein the first attachment device is a first safety pin, and the second attachment is a second safety pin.

3. A method of using a cell phone case comprising:
providing the cell phone case of claim 2;
affixing the first safety pin to the user's clothing;
affixing the second safety pin to the user's clothing; and
recording a video with a cell phone housed in the cell phone case.
